(19) United States
(12) Patent Application Publication
(10) Pub. No.: US 2006/0153944 A1
(43) Pub. Date: Jul. 13, 2006

(54) Injection molding nozzle tip

(75) Inventor: Vince Ciccone, Kleinburg (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: INJECTNOTECH INC., Mississauga (CA)

(21) Appl. No.: 11/319,757

(22) Filed: Dec. 27, 2005

Related U.S. Application Data
(60) Provisional application No. 60/641,219, filed on Dec. 30, 2004.

(51) Int. Cl. B29C 45/22

(52) U.S. Cl. 425/564

(57) ABSTRACT

A series of injection molding nozzles, one series having a two-piece nozzle, and another series having a three-piece injection molding nozzle. The two-piece nozzles include an inner insert and an outer insert portions. The three-piece nozzles include an inner insert, an outer insert, and a sealing surrounding piece portions. An aspect of the invention is directed to forming a secondary seal with the mold pocket and having a torquing portion for the outer inserts located behind the secondary seal.

### CROSS-REFERENCES TO RELATED APPLICATIONS

This application claims priority to U.S. Provisional Patent Application No. 60/641,219, filed Dec. 30, 2004, which is related to U.S. patent application Ser. No. 10/934,544, filed on Sep. 3, 2004, which claims priority to U.S. Provisional Application No. 60/500,442, filed on Sep. 5, 2003, and U.S. patent application Ser. No. 11/286,266, filed Nov. 22, 2005, which claims priority to U.S. Provisional Application No. 60/630,266, filed on Nov. 22, 2004; the disclosures of which are hereby incorporated by reference herein in their entirety for all purposes.

### BACKGROUND OF THE INVENTION

The present invention relates to plastic injection molds, and in particular, to nozzles for the hot runner system of such injection molds.

### BRIEF SUMMARY OF THE INVENTION

The present invention is directed towards a series of injection molding nozzles, one series having a two-piece nozzle, and another series having a three-piece injection molding nozzle. The two-piece nozzles include an inner insert and an outer insert portions. The three-piece nozzles include an inner insert, an outer insert, and a sealing surrounding piece portions. An aspect of the invention is directed to forming a secondary seal with the mold pocket and having a torquing portion for the outer inserts located behind the secondary seal.

For a further understanding of the nature and advantages of the invention, reference should be made to the following description taken in conjunction with the accompanying drawings.

### BRIEF DESCRIPTION OF THE DRAWINGS

FIG. 1 is an exemplary vertical sectional view of a first embodiment of an injection molding nozzle in accordance with the present invention, showing an assembled two-piece injection molding nozzle having a diverted-flow tip and a conventional primary seal, used with a conventional nozzle housing, shown in the mold pocket.

FIG. 1A is an exemplary horizontal sectional view along line A-A of FIG. 1.

FIG. 1B is an exemplary vertical sectional view of a first embodiment of an injection molding nozzle in accordance with the present invention, showing an assembled two-piece injection molding nozzle having a diverted-flow tip and a conventional primary seal, for use with a conventional nozzle housing, shown removed from the mold pocket.

FIG. 1C is an exemplary horizontal view along line B-B of FIG. 1B.

FIG. 1D is an exemplary horizontal sectional view along line C-C of FIG. 1B.

FIG. 1E is an exemplary vertical sectional view of a first embodiment of an injection molding nozzle in accordance with the present invention, showing an assembled two-piece injection molding nozzle having a diverted-flow tip and a conventional primary seal, used with a conventional nozzle housing, shown in the mold pocket during injection.

FIG. 1F is an exemplary vertical sectional view of a first embodiment of an injection molding nozzle in accordance with the present invention, showing an assembled two-piece injection molding nozzle having a diverted-flow tip and a modified primary seal (allowing the formation of an additional insulator), used with a conventional nozzle housing, shown in the mold pocket during injection.

FIG. 2 is an exemplary vertical sectional view of a first embodiment of an injection molding nozzle in accordance with the present invention, showing an assembled two-piece injection molding nozzle having a flow-through tip and a conventional primary seal, used with a conventional nozzle housing, shown in the mold pocket.

FIG. 2A is an exemplary vertical sectional view of a first embodiment of an injection molding nozzle in accordance with the present invention, showing an assembled two-piece injection molding nozzle having a flow-through tip and a conventional primary seal, for use with a conventional nozzle housing, shown removed from the mold pocket.

FIG. 2B is an exemplary horizontal view along line D-D of FIG. 2A.

FIG. 2C is an exemplary horizontal sectional view along line E-E of FIG. 2A.

FIG. 2D is an exemplary vertical sectional view of a first embodiment of an injection molding nozzle in accordance with the present invention, showing an assembled two-piece injection molding nozzle having a flow-through tip and a conventional primary seal, used with a conventional nozzle housing, shown in the mold pocket during injection.

FIG. 2E is an exemplary vertical sectional view of a first embodiment of an injection molding nozzle in accordance with the present invention, showing an assembled two-piece injection molding nozzle having a flow-through tip and a modified primary seal (allowing the formation of an additional insulator), used with a conventional nozzle housing, shown in the mold pocket during injection.

FIG. 3 is an exemplary vertical sectional view of a first embodiment of an injection molding nozzle in accordance with the present invention, showing an assembled two-piece injection molding nozzle having a valve-gate style tip and a conventional primary seal, used with a conventional nozzle housing, shown in the mold pocket.

FIG. 3A is an exemplary vertical sectional view of a first embodiment of an injection molding nozzle in accordance with the present invention, showing an assembled two-piece injection molding nozzle having a valve-gate style tip and a conventional primary seal, used with a conventional nozzle housing, shown in the mold pocket during injection.

FIG. 3B is an exemplary vertical sectional view of a first embodiment of an injection molding nozzle in accordance with the present invention, showing an assembled two-piece injection molding nozzle having a valve-gate style tip and a modified primary seal (allowing the formation of an additional insulator), used with a conventional nozzle housing, shown in the mold pocket during injection.

FIG. 4 is an exemplary vertical sectional view of a second embodiment of an injection molding nozzle in accordance with the present invention, showing an assembled three-piece injection molding nozzle having a diverted-flow tip, a conventional primary seal and a conventional sealing surrounding piece providing the secondary seal, used with a conventional nozzle housing, shown in the mold pocket.

FIG. 4A is an exemplary horizontal sectional view along line F-F of FIG. 4.

FIG. 4B is an exemplary vertical sectional view of a second embodiment of an injection molding nozzle in accordance with the present invention, showing an assembled three-piece injection molding nozzle having a diverted-flow tip, a conventional primary seal and a conventional sealing surrounding piece providing the secondary seal, used with a conventional nozzle housing, shown in the mold pocket during injection.

FIG. 4C is an exemplary vertical sectional view of a second embodiment of an injection molding nozzle in accordance with the present invention, showing an assembled three-piece injection molding nozzle having a diverted-flow tip, a modified primary seal (allowing the formation of an additional insulator) and a conventional sealing surrounding piece providing the secondary seal, used with a conventional nozzle housing, shown in the mold pocket during injection.

FIG. 5 is an exemplary vertical sectional view of a second embodiment of an injection molding nozzle in accordance with the present invention, showing an assembled three-piece injection molding nozzle having a flow-through tip, a conventional primary seal and a conventional sealing surrounding piece providing the secondary seal, used with a conventional nozzle housing, shown in the mold pocket.

FIG. 5A is an exemplary vertical sectional view of a second embodiment of an injection molding nozzle in accordance with the present invention, showing an assembled three-piece injection molding nozzle having a flow-through tip, a conventional primary seal and a conventional sealing surrounding piece providing the secondary seal, used with a conventional nozzle housing, shown in the mold pocket during injection.

FIG. 5B is an exemplary vertical sectional view of a second embodiment of an injection molding nozzle in accordance with the present invention, showing an assembled three-piece injection molding nozzle having a flow-through tip, a modified primary seal (allowing the formation of an additional insulator) and a conventional sealing surrounding piece providing the secondary seal, used with a conventional nozzle housing, shown in the mold pocket during injection.

FIG. 6 is an exemplary vertical sectional view of a second embodiment of an injection molding nozzle in accordance with the present invention, showing an assembled three-piece injection molding nozzle having a valve-gate style tip, a conventional primary seal and a conventional sealing surrounding piece providing the secondary seal, used with a conventional nozzle housing, shown in the mold pocket.

FIG. 6A is an exemplary vertical sectional view of a second embodiment of an injection molding nozzle in accordance with the present invention, showing an assembled three-piece injection molding nozzle having a valve-gate style tip, a conventional primary seal and a conventional sealing surrounding piece providing the secondary seal, used with a conventional nozzle housing, shown in the mold pocket during injection.

FIG. 6B is an exemplary vertical sectional view of a second embodiment of an injection molding nozzle in accordance with the present invention, showing an assembled three-piece injection molding nozzle having a valve-gate style tip, a modified primary seal (allowing the formation of an additional insulator) and a conventional sealing surrounding piece providing the secondary seal, used with a conventional nozzle housing, shown in the mold pocket during injection.

### DETAILED DESCRIPTION OF THE INVENTION

The first embodiment of the present invention presents a two-piece injection-molding nozzle used with a conventional nozzle housing. As used herein, the term conventional refers to an unmodified variant of the piece, for example a conventional housing is an unmodified housing, or a conventional seal is an unmodified seal.

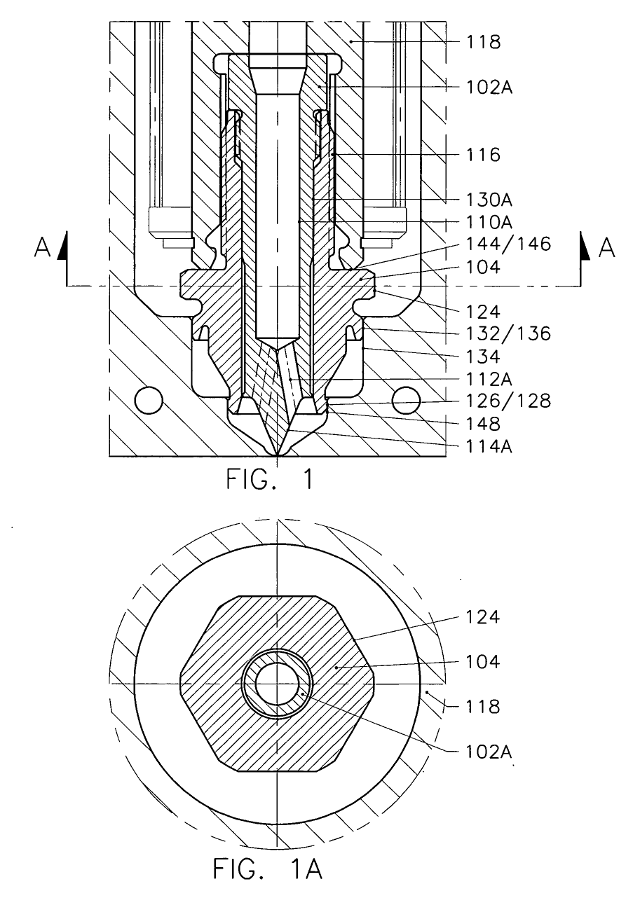

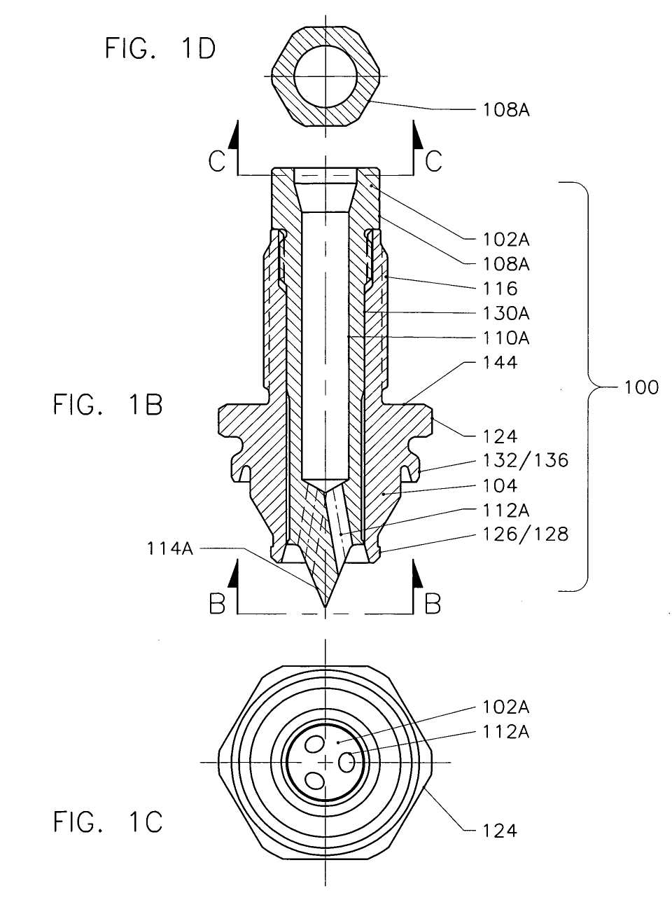

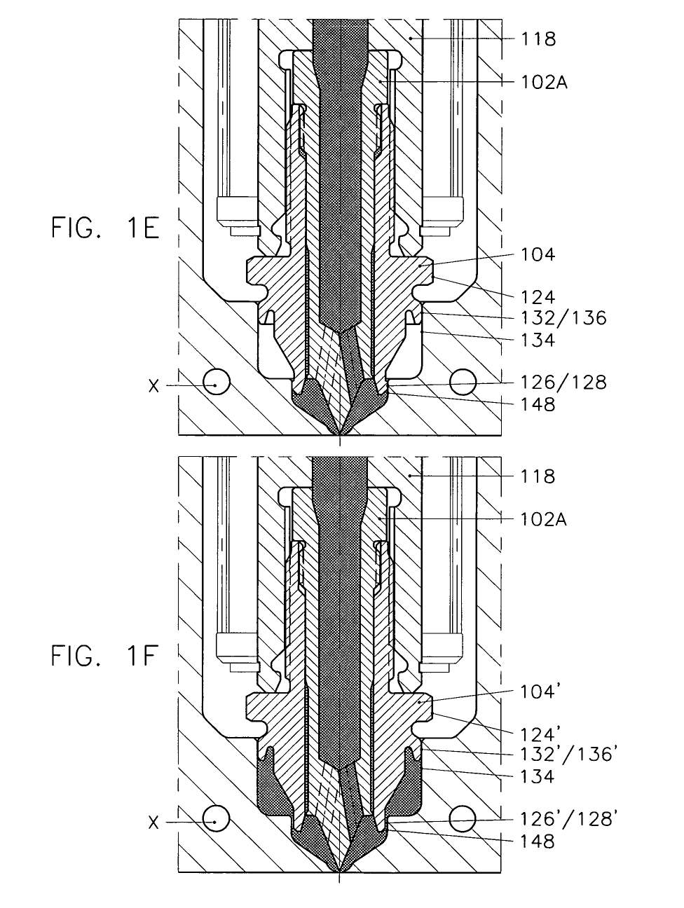

FIGS. 1, 1B, 1E and 1F are exemplary vertical sectional views of a first embodiment of an injection molding nozzle in accordance with the present invention showing an assembled two-piece injection molding nozzle 100 having a diverted-flow tip. As is shown in FIGS. 1 through 1E, the nozzle insert of this design is made of two components: an inner insert 102A (diverted-flow style) and an outer insert 104 (having a conventional primary seal). FIG. 1F presents a two-piece nozzle tip similar to the one of FIGS. 1 through 1E, but one that has a modified primary seal on the outer insert 104′, allowing formation of an additional insulator. This modified primary seal is described in more detail below. For FIGS. 1 through 1F, the inner and outer inserts are made of the same or similar materials, with high thermal conductivity, such as beryllium copper alloys. Alternately, the outer insert is made of a harder, and/or more wear-resistant alloy.

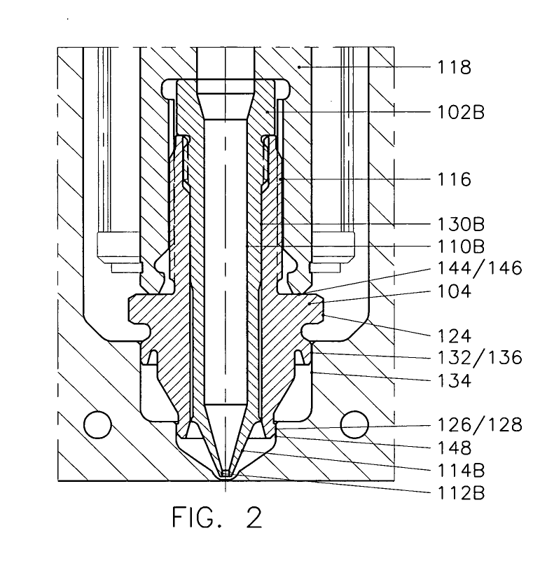

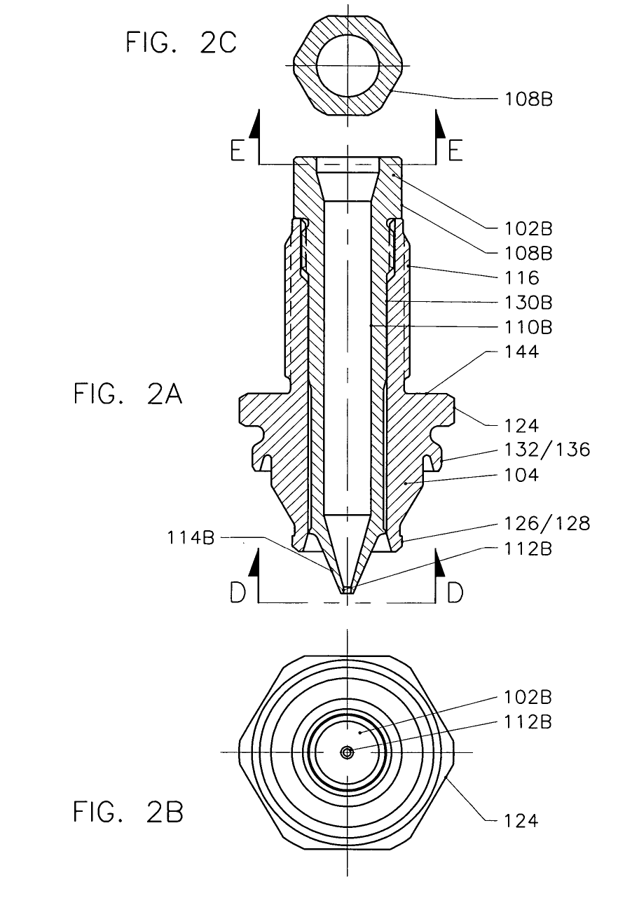

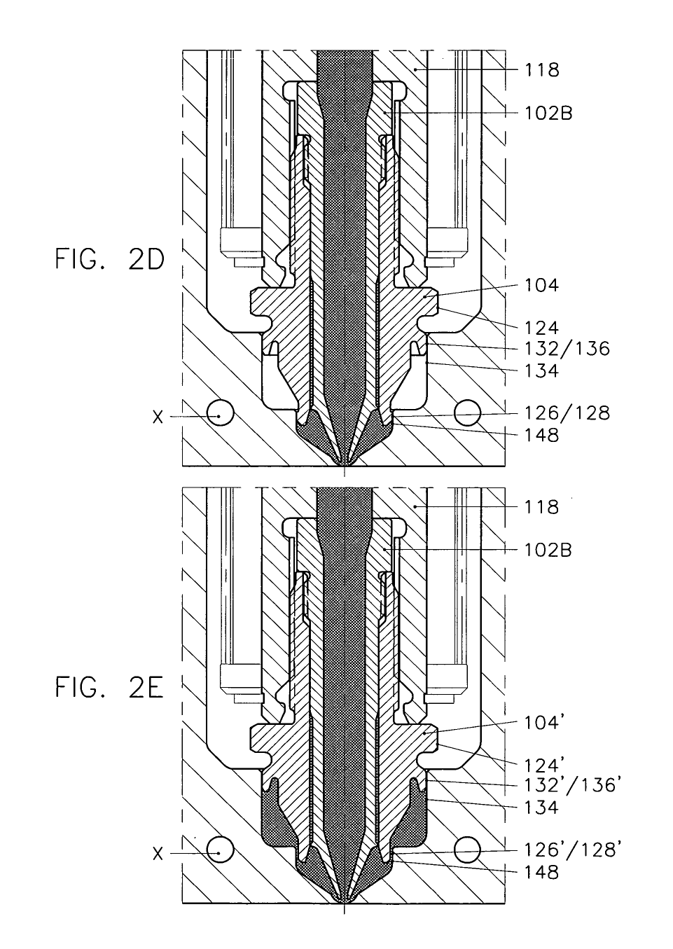

The back end of the inner insert 102A has a shape designed for torquing, such as for example a hexagon head 108A as shown in FIG. 1D. The inner insert 102A is threadably engaged in the outer insert 104. It should be noted that the inner insert can slidably engage the outer insert, where the inner insert slides into the outer insert until the inner insert rests against the shoulder portion of the outer insert. On the inside, the diverted-flow inner insert has a large central duct 110A, from which a number of smaller holes 112A (usually three evenly-spaced holes, as shown in FIG. 1C) extend to the conical end of tip 114A. The flow-through style inner insert 102B (as shown in FIGS. 2 through 2E) has a large central duct 110B, tapering off to a small central hole 112B at the conical end of the tip 114B. FIGS. 2 through 2D show an outer insert with conventional primary seal, while FIG. 2E shows an outer insert with a modified primary seal. The seal embodiments are described below.

As shown in FIGS. 1 through 1E, on the outside the outer insert has a threaded portion 116 for engagement in a conventional nozzle housing 118, followed by portion having a shape designed for torquing, such as for example hexagon 124, a cylindrical portion 132 which seals against mold pocket 134 to achieve the secondary seal 136, and a small cylindrical portion 126 which constitutes the conventional primary seal 128, sealing against mold pocket 148. Centering between the inner and outer inserts takes place on the cylindrical surface 130A of contact between them.

The outer geometry of this nozzle tip unit is designed to allow interchangeability with older styles (when used with conventional nozzle housings), such as those offered by Top Grade Molds of Ontario, Canada, and described in U.S. Pat. No. 6,394,785, the disclosure of which is hereby incorporated by reference herein. The interchangeability enables the new nozzle tips, with added features, to easily replace previous designs of tips when molds are overhauled or upgraded.

This first embodiment offers several advantages over existing injection molding nozzles. One advantage is that the nozzle tip 100 is pre-assembled and stocked as a one-piece unit. The threaded engagement between the inner and outer inserts prevents accidental fall and possible damage of either during handling. Also, the present invention as described in conjunction with FIGS. 1 through 1E and 2 through 2D has a built-in double seal: the conventional primary seal 128 at the front of the outer insert 104, and the secondary seal 136, at the front of the hexagon portion 124 of the outer insert 104. Furthermore, the hexagon portion 124 of the outer insert 104 is located behind the secondary seal 136, and as such remains clean of molten plastic even when the outer insert has a modified primary seal, as explained in more detail below. This eliminates the time-consuming operation of cleaning around the hexagon portion when necessary to replace the nozzle tip.

The pre-assembled nozzle tip unit 100 can be taken off the shelf and threaded in the conventional nozzle housing 118, as shown in FIGS. 1, 1B, 2 and 2A, until back surface 144 of the outer insert 104, located behind the hexagon portion 124, tightens against the front end 146 of the conventional nozzle housing 118, ensuring a leak-proof contact.

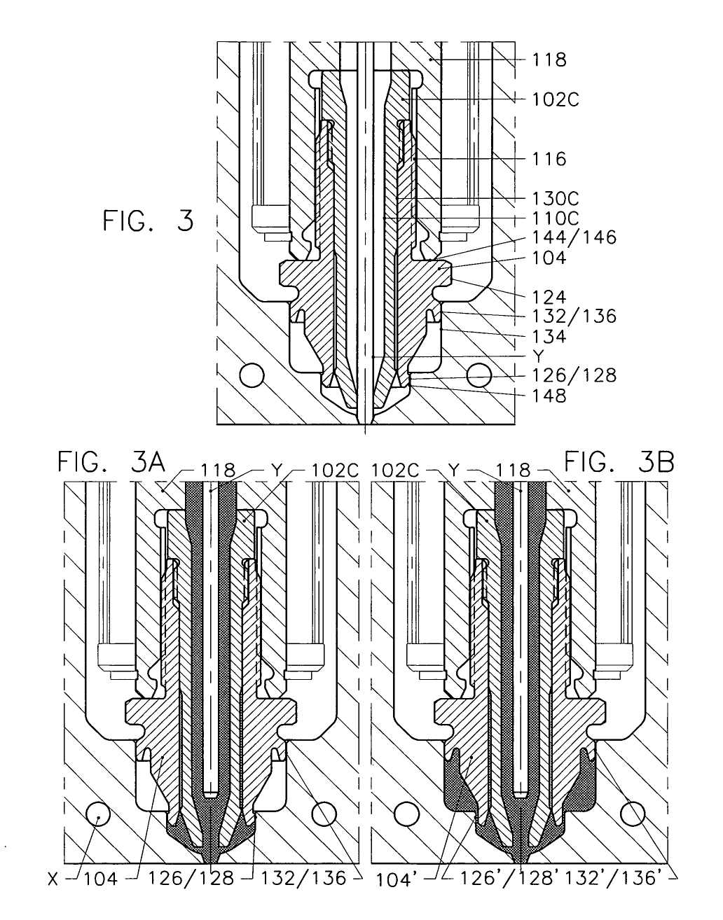

An adaptation of the first embodiment, presenting a modified primary seal 128′, is shown in FIG. 1F. It makes use of inner insert 102A and an outer insert 104′ having a reduced cylindrical portion 126′, the nozzle tip being employed with a conventional nozzle housing 118. The modified primary seal 128′ does not stop the molten plastic under injection pressure, but rather allows it to reach behind the reduced cylindrical portion 126′, to fill the chamber at the front of the secondary seal 136′. Cooling lines X crossing through the mold help solidify the plastic formed behind the reduced cylindrical portion 126′; this solidified plastic becomes an additional insulator, further reducing heat loss from heated nozzle tip to cooled mold. The annular gap between the reduced cylindrical portion 126′ and the mold pocket 148 is sufficiently small to prevent the plastic of the additional insulator from seeping back to the front of the nozzle tip, allowing for clean color changes. The pressure differential (i.e., injection pressure at the front of the nozzle tip is far higher than the pressure of the plastic of the additional insulator) also helps prevent such seepage. This design can also be used with inner insert 102B (flow-through), as can be seen in FIG. 2E, and with inner insert 102C (valve-gate style), as can be seen in FIG. 3B. As explained in the co-pending patent applications referred to above, when a color change is in order, the mold is shut down and allowed to cool. The plastic left in the annular well at the front of the nozzle tip (usually known as the cold slug) solidifies. When the nozzle tip is exposed, the cold slug can be twisted to break the thin membrane that connects it to the solidified plastic of the additional insulator. The additional insulator (of the old color of plastic) is confined in the chamber located behind the modified primary seal, while the cold slug is removed, leaving a clean front of the tip. The new color of plastic can be injected, without any leaks from the additional insulator. In the case of conventional primary seal, the cold slug is even easier to remove, as there is no membrane connection to break.

It should be noted that the inner and outer inserts of designs of FIGS. 2 through 2E, and also of FIGS. 3 through 3B, are made of the same or similar materials, for example, a high thermal conductivity material such as beryllium copper alloys. Alternately, the outer inserts of these designs is made of a harder, and/or more wear-resistant alloy.

FIGS. 3, 3A and 3B show an adaptation of the first embodiment for use with a valve-gate style nozzle tip and with a conventional nozzle housing 118. FIGS. 3 and 3A employ a conventional primary seal 128; FIG. 3B uses a modified primary seal 128′.

The outer inserts 104, 104′ used are the ones previously described. The inner insert 102C is adapted for a valve-gate style seal with valve stem Y. As is typical of such gates, the valve stem is retracted by some means that is not described here, to allow flow of molten plastic into the injection chamber.

The modified primary seal 128′ of FIG. 3B allows molten plastic to reach all the way to the front of the secondary seal 136′, in the manner described above, providing an additional insulator to prevent further heat loss from heated nozzle tip to cooled mold.

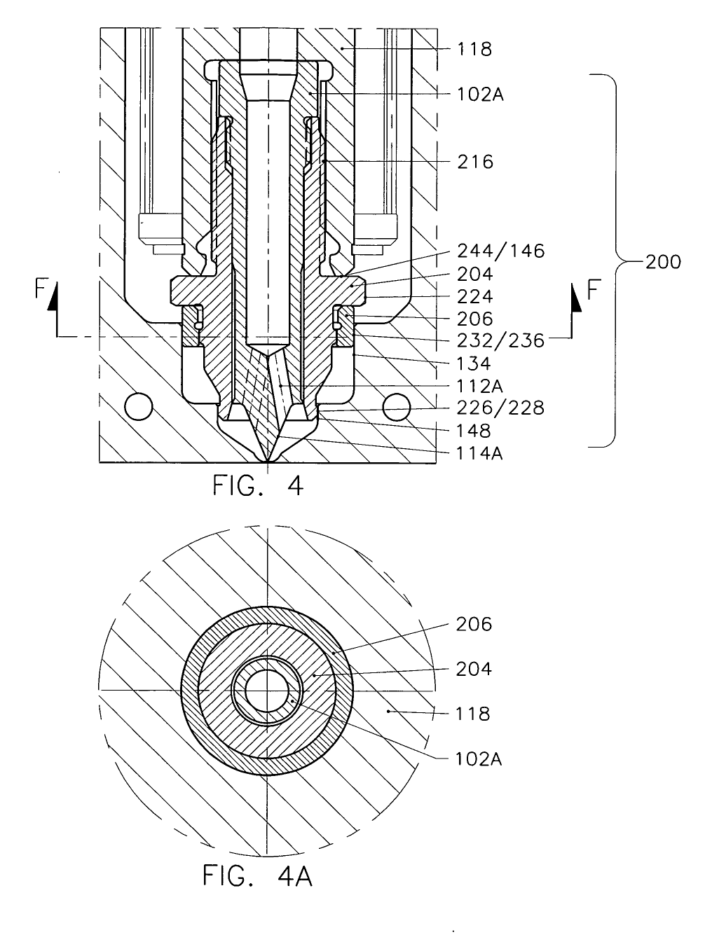

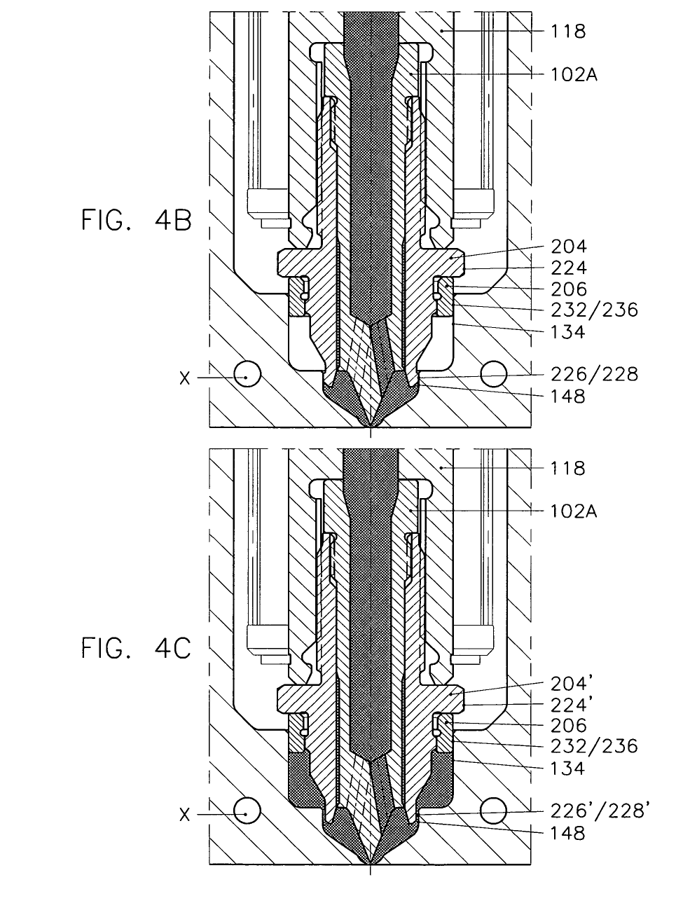

A second embodiment is described below with reference to FIGS. 4 through 4C. As is shown in FIGS. 4 and 4B, the nozzle insert 200 of this design is made of three components: an inner insert 102A (diverted-flow), an outer insert 204 (having a conventional primary seal) and a conventional sealing surrounding piece 206. FIG. 4C presents a three-piece nozzle tip similar to the one of FIGS. 4 through 4B, but one that has a modified primary seal on the outer insert, allowing formation of an additional insulator. This modified seal is described in more detail below. For FIGS. 4 through 4C, the inner and outer inserts are made of the same or similar materials, for example a high thermal conductivity material, such as beryllium copper alloys, while the conventional sealing surrounding piece can be made of either the same or similar material as the inner and outer inserts, or of any other suitable material, such as for example a harder, and/or more wear-resistant material or alloy.

The outer insert 204 of this second embodiment is shaped to allow a press-fit engagement of a conventional sealing surrounding piece 206. The secondary seal 236 is thus achieved between outer surface 232 of conventional sealing surrounding piece 206 and mold pocket 134. Many other design aspects of the three-piece nozzle insert embodiments are similar to those of the above-described two-piece embodiments, and thus will not be repeated here for efficiency. For example, the inner insert of the three-piece embodiments threadably engages in the outer insert. Or the inner insert can slidably engage the outer insert, where the inner insert slides into the outer insert until the inner insert rests against the shoulder portion of the outer insert.

This embodiment has all the advantages brought by the previous embodiment. One such advantage is its interchangeability with older styles (when used with conventional nozzle housings) such as those offered by Top Grade Molds of Ontario, Canada, and described in U.S. Pat. No. 6,394,785. The interchangeability enables the new nozzle tips with added features, to easily replace previous designs of tips when molds are overhauled or upgraded. Furthermore, this design presents a replaceable secondary seal (as part of the conventional sealing surrounding piece 206), which is useful for mature molds. If, after repeated cleanings or overhauls, the mold pocket 134 (where the secondary seal 236 takes place) has been enlarged, sealing can be re-achieved by using an oversized replacement sealing surrounding piece. This is a cost-effective and waste-reducing solution, by eliminating the need to replace the entire nozzle tip in such cases. Also, the secondary seal has a longer life when the conventional sealing surrounding piece is made of a harder, and/or more wear-resistant alloy.

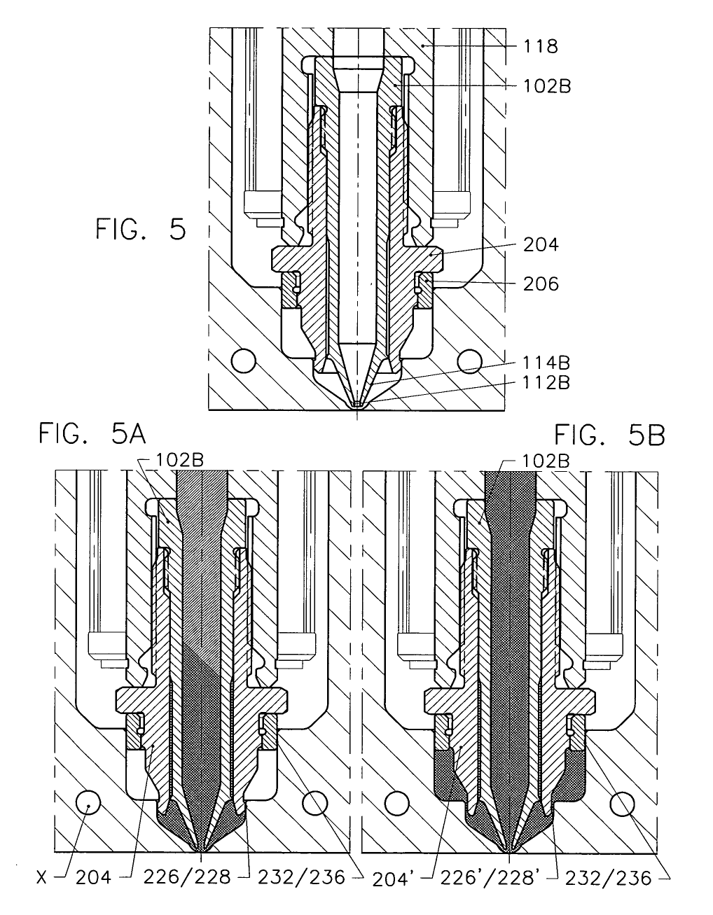

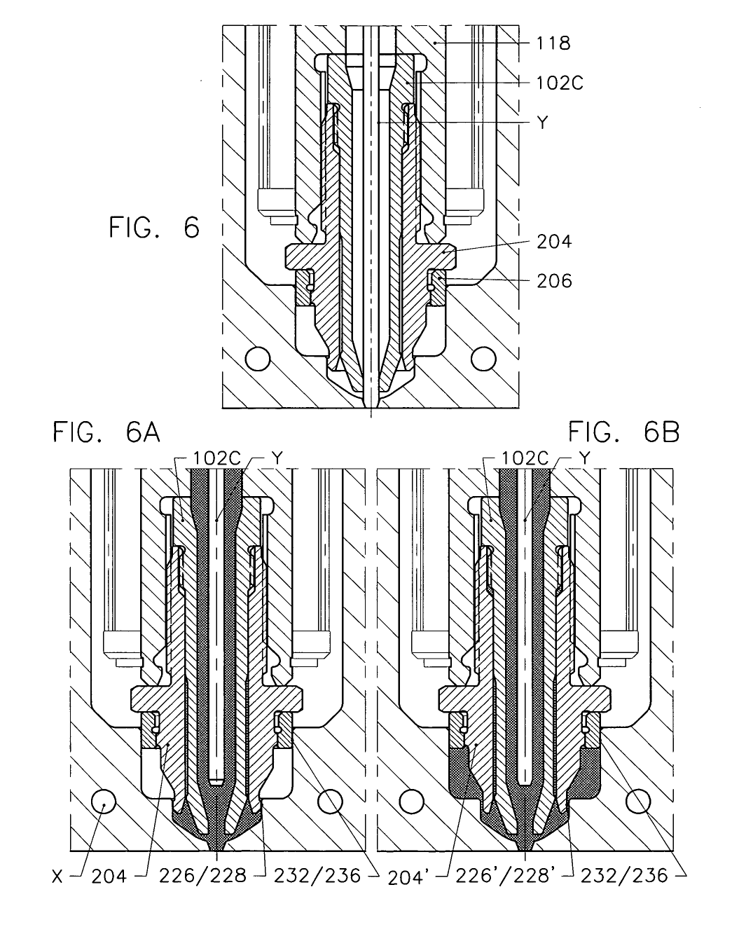

This second embodiment could also be employed with flow through style tip (using inner insert 102B), as shown in FIG. 5, or with valve-gate style tip (using inner insert 102C), as shown in FIG. 6. FIG. 5A shows the second embodiment when used with flow-through tip 102B and with outer insert 204 having a conventional primary seal 228, in the mold pocket during injection. FIG. 5B shows the second embodiment when used with flow-through tip 102B and with outer insert 204′ having a modified primary seal 228′ which allows formation of an additional insulator extending all the way to the front of the secondary seal 236. Similarly, FIG. 6A presents the second embodiment when used with valve-gate style tip 102C, and with outer insert 204 having a conventional primary seal 228, in the mold pocket during injection. FIG. 6B shows the second embodiment when used with valve-gate style tip 102C and with outer insert 204′ having a modified primary seal 228′ which allows formation of an additional insulator extending all the way to the front of the secondary seal 236.

All the embodiments described above (with all their variations) have another feature that is described in co-pending U.S. patent application. Ser. No. 10/934,544, filed on Sep. 3, 2004, namely the plastic thermo-barrier formed between the inner and outer inserts. As molten plastic fills the annular well around the conical end of the tip, injection pressure forces it behind the small annular shoulder of the inner insert, and inside the tubular relief formed between the inner insert and outer insert. This plastic (that cannot seep back at the front of the tip due to pressure differential, thus allowing clean color changes) acts as a tubular thermo-barrier, reducing heat loss from inner insert to the outer insert (which is in contact with the cooled mold). This thermo-barrier is sufficiently long to extend past the location of the secondary seal, where heat loss would otherwise be most likely to occur.

As will be understood by those skilled in the art, the present invention may be embodied in other specific forms without departing from the essential characteristics thereof.

What is claimed is:

1. An injection molding nozzle, comprising:
an outer insert; and
an inner insert configured to engage the outer insert, the inner insert configured for being centered within the outer insert, wherein centering between the inner insert and outer insert occurs along a cylindrical surface of contact between them,
wherein on the inside the inner insert has a central duct for the delivery of molten plastic to a conical end of the inner insert, and
wherein on the outside the outer insert has a threaded portion for engagement in a nozzle housing, followed by a portion having a shape designed for torquing, followed by a cylindrical portion dimensioned to form a seal against a mold pocket to form a secondary seal, and followed by a smaller diameter cylindrical portion which is dimensioned to form a primary seal against the mold pocket.

2. The injection molding nozzle of claim 1 wherein the inner insert is configured to threadably engage the outer insert.

3. The injection molding nozzle of claim 1 wherein the inner insert is configured to slidably engage the outer insert.

4. The injection molding nozzle of claim 1 wherein the portion having a shape designed for torquing is hexagon-shaped.

5. The injection molding nozzle of claim 1 wherein the primary seal is formed near a front portion of the outer insert.

6. The injection molding nozzle of claim 1 wherein the secondary seal is formed near a front portion of the portion having a shape designed for torquing of the outer insert.

7. The injection molding nozzle of claim 1 comprising a gap between the smaller cylindrical portion of the outer insert and the mold pocket to form a modified primary seal, whereby during injection of molten plastic, the gap allows the flow of molten plastic to flow back through the gap and at least partially fill a space between the gap and the secondary seal, between the mold pocket and the nozzle, such that when solidified and/or semi-solidified, the molten plastic in the space provides additional thermal insulation.

8. The injection molding nozzle of claim 1 wherein the inner insert and the outer insert are made of a same or similar high thermal conductivity material.

9. The injection molding nozzle of claim 8 wherein the material comprises a beryllium copper alloy.

10. The injection molding nozzle of claim 1 wherein the outer insert is made of a harder and more wear-resistant material than that of the inner insert.

11. The injection molding nozzle of claim 1 wherein the central duct is configured to be in fluid communication with at least one smaller diameter duct extending through to the front end of the inner insert.

12. The injection molding nozzle of claim 1 wherein the central duct is configured to be in fluid communication with one smaller diameter duct extending through to the front end of the inner insert.

13. The injection molding nozzle of claim 1 wherein the central duct is configured to be in fluid communication with one smaller diameter duct extending through to the front end of the inner insert, and wherein a valve stem is used to control the flow of molten plastic through the smaller diameter duct.

14. An injection molding nozzle, comprising:
an outer insert;
an inner insert configured to engage the outer insert, the inner insert configured for being centered within the outer insert, wherein centering between the inner insert and outer insert occurs along a cylindrical surface of contact between them; and
a sealing surrounding piece,
wherein on the inside the inner insert has a central duct for the delivery of molten plastic to a conical end of the inner insert, and
wherein on the outside the outer insert has a threaded portion for engagement in a nozzle housing, followed by a portion having a shape designed for torquing, and followed by a smaller diameter cylindrical portion which is dimensioned to form a primary seal against a mold pocket, and
wherein the sealing surrounding piece is dimensioned for being press-fitted against and around the outside of the outer insert and against the portion having a shape designed for torquing, an outer surface of the sealing surrounding piece being dimensioned to form a seal against the mold pocket to form a secondary seal.

15. The injection molding nozzle of claim 14 wherein the inner insert is configured to threadably engage the outer insert.

16. The injection molding nozzle of claim 14 wherein the inner insert is configured to slidably engage the outer insert.

17. The injection molding nozzle of claim 14 wherein the portion having a shape designed for torquing is hexagon-shaped.

18. The injection molding nozzle of claim 14 wherein the primary seal is formed near a front portion of the outer insert.

19. The injection molding nozzle of claim 14 wherein the secondary seal is formed near a portion of the sealing surrounding piece.

20. The injection molding nozzle of claim 14 comprising a gap between the smaller cylindrical portion of the outer insert and the mold pocket to form a modified primary seal, whereby during injection of molten plastic, the gap allows the flow of molten plastic to flow back through the gap and at least partially fill a space between the gap and the secondary seal, between the mold pocket and the nozzle, such that when solidified and/or semi-solidified, the molten plastic in the space provides additional thermal insulation.

21. The injection molding nozzle of claim 14 wherein the inner insert, the outer insert, and the sealing surrounding piece are made of a same or similar high thermal conductivity material.

22. The injection molding nozzle of claim 21 wherein the material comprises a beryllium copper alloy.

23. The injection molding nozzle of claim 14 wherein the sealing surrounding piece is made of a harder and more wear-resistant material than that of the inner insert or the outer insert.

24. The injection molding nozzle of claim 14 wherein the central duct is configured to be in fluid communication with at least one smaller diameter duct extending through to the front end of the inner insert.

25. The injection molding nozzle of claim 14 wherein the central duct is configured to be in fluid communication with one smaller diameter duct extending through to the front end of the inner insert.

26. The injection molding nozzle of claim 14 wherein the central duct is configured to be in fluid communication with one smaller diameter duct extending through to the front end of the inner insert, and wherein a valve stem is used to control the flow of molten plastic through the smaller diameter duct.
